(19) United States
(12) Patent Application Publication
(10) Pub. No.: US 2013/0061423 A1
(43) Pub. Date: Mar. 14, 2013

(54) BUSHING ASSEMBLY AND METHOD OF ASSEMBLING SAME

(71) Applicants: Rebecca Elizabeth Ahern, Renton, WA (US); Christopher L. Newbolt, Seattle, WA (US); James P. Irwin, Renton, WA (US); Peter A. Coronado, Renton, WA (US); Benjamin A. Johnson, Lynnwood, WA (US)

(72) Inventors: Rebecca Elizabeth Ahern, Renton, WA (US); Christopher L. Newbolt, Seattle, WA (US); James P. Irwin, Renton, WA (US); Peter A. Coronado, Renton, WA (US); Benjamin A. Johnson, Lynnwood, WA (US)

(21) Appl. No.: 13/230,309

(22) Filed: Sep. 12, 2011

(51) Int. Cl. F16L 5/00; B23P 11/00

(52) U.S. Cl. 16/2.1; 29/505

(57) ABSTRACT

A bushing assembly includes a washer that includes an opening defined therethrough. A cylindrical body includes a first end that is sized to be inserted within the washer opening and an opposite second end. The cylindrical body is fabricated from a smart material that is configured to selectively expand when at least a portion of the body is positioned within the washer opening.

### FIELD OF THE DISCLOSURE

The present disclosure relates generally to bushings and, more particularly, to bushing systems that include a bushing component and a separate flange.

### BACKGROUND

At least some known bushings, such as some known shape-memory bushings, are installed by expanding the bushing within an opening. For example, to install such shape-memory bushings, heat and/or other energy is applied to transform the bushing from a strained, martensitic state to a shaped, austenitic state. During the transformation, the bushing expands radially outward to fill the opening and thus becomes coupled within the opening in an interference fit. Generally, the expansion is reversible by applying energy that is opposite to the originally applied energy. For example, if heat was used to secure the bushing within an opening, the bushing can generally be removed from the opening when significantly cooled using liquid nitrogen or some other cooling source.

At least some applications, however, require more complex bushings that include additional features and/or characteristics, such as flanges. Depending on their use, at least some known flanged bushings are installed using shrink-fit technology and/or using brute force applied by, for example, a mandrel. As can be appreciated, such installation methods, however, may damage the bushing and/or the structure in which the bushing is being installed, thus resulting in a defective installation. As such, the use of shape-memory bushings may be limited. Moreover, shape-memory technology is generally not used to install flanged bushings because different parts of such bushings generally expand at different rates.

Therefore, it would be advantageous to have a method and apparatus that takes into account at least some of the issues discussed above, as well as possibly other issues.

### SUMMARY

In one aspect, a bushing assembly is provided. The bushing assembly includes a washer that includes an opening defined therethrough. A cylindrical body includes a first end that is sized to be inserted within the washer opening and an opposite second end. The cylindrical body is fabricated from a smart material that is configured to selectively expand when at least a portion of the body is positioned within the washer opening.

In another aspect, a bushing is provided for use with a washer including an opening defined therethrough. The bushing includes a cylindrical body including a first end that is sized to be inserted within the washer opening and an opposite second end. The cylindrical body is fabricated from a smart material that is configured to selectively expand when at least a portion of the body is positioned within the washer opening.

In yet another aspect, a method is provided for assembling a bushing assembly. The method includes positioning a first end of a cylindrical body within an opening defined by a washer. The cylindrical body is fabricated from a smart material that is configured to selectively expand. The cylindrical body is expanded when the body first end is positioned within the washer opening.

The features, functions, and advantages described herein may be achieved independently in various embodiments of the present disclosure or may be combined in yet other embodiments, further details of which may be seen with reference to the following description and drawings.

### BRIEF DESCRIPTION OF THE DRAWINGS

FIG. 1 is a side view of an exemplary bushing assembly;

FIG. 2 is a bottom perspective view of the bushing assembly shown in FIG. 1;

FIG. 3 is a side view of an exemplary flange component that may be used with the bushing assembly shown in FIG. 1;

FIG. 4 is a top perspective view of the flange component shown in FIG. 3;

FIG. 5 is a side view of an exemplary bushing component that may be used with the bushing assembly shown in FIG. 1;

FIG. 6 is a bottom perspective view of the bushing component shown in FIG. 5; and

FIG. 7 is a flowchart of an exemplary method that may be implemented to assemble the bushing assembly shown in FIG. 1.

Although specific features of various embodiments may be shown in some drawings and not in others, this is for convenience only. Any feature of any drawing may be referenced and/or claimed in combination with any feature of any other drawing.

### DETAILED DESCRIPTION

The subject matter described herein relates generally to bushings and, more particularly, to bushing systems that include a bushing component and a separate flange component. In one embodiment, the flange component is a washer that includes an opening defined therethrough and the bushing component is a cylindrical body that has a first end that is sized to fit within the washer opening. The cylindrical body is fabricated from a smart material that is configured to expand. As such, the bushing component and/or the flange component are predictably expandable, thus enabling shape-memory technology to be used for bushing installation applications.

As used herein, a “smart material” refers to a material that has one or more properties that is selectively changeable using an external stimuli including, without limitation, stress, temperature, moisture, pH, electric field, and/or magnetic field. As used herein, a “shape-memory material” refers to a material that has a shape that is selectively changeable using an external stimuli including, without limitation, stress, temperature, moisture, pH, electric field, and/or magnetic field.

As used herein, an element or step recited in the singular and proceeded with the word “a” or “an” should be understood as not excluding plural elements or steps unless such exclusion is explicitly recited. Moreover, references to “one embodiment” of the present invention and/or the “exemplary embodiment” are not intended to be interpreted as excluding the existence of additional embodiments that also incorporate the recited features.

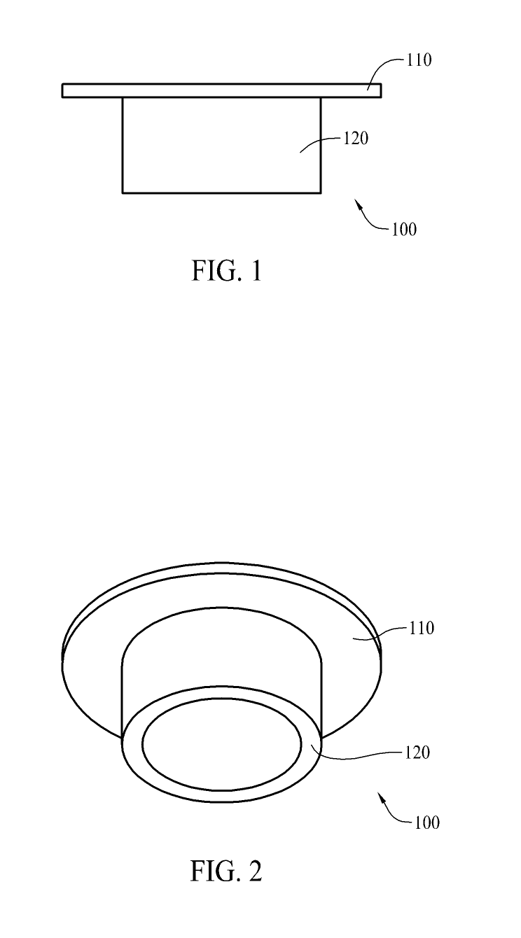

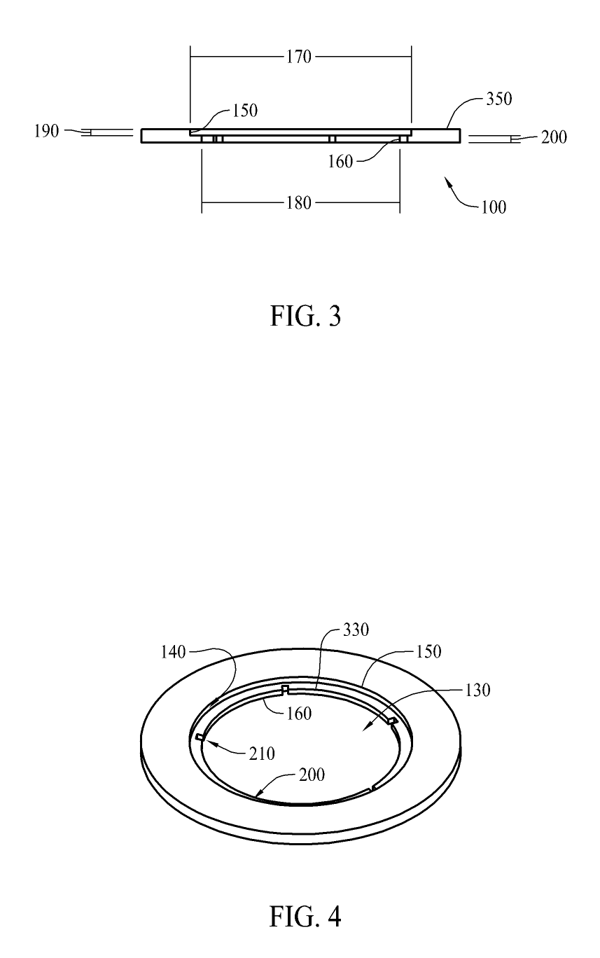

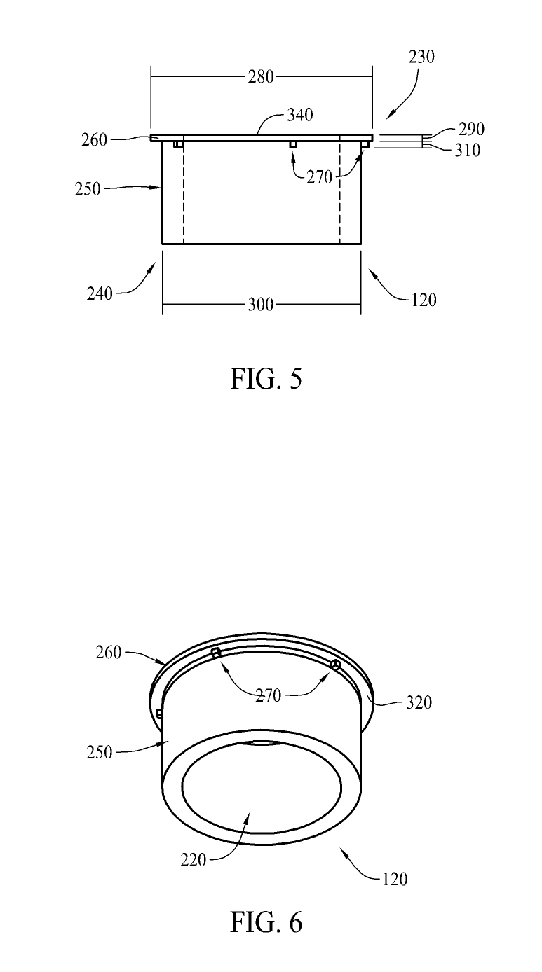

FIGS. 1 and 2 each illustrate an exemplary bushing assembly 100 that includes a flange component or washer 110, and a bushing component or body 120, coupled to washer 110. FIGS. 3 and 4 illustrate washer 110. FIGS. 5 and 6 illustrate body 120. In the exemplary embodiment, washer 110 is a substantially planar disk that includes an opening 130 defined therethrough. In the exemplary embodiment, opening 130 is sized to receive at least a portion of body 120 therein. More specifically, in the exemplary embodiment, washer 110 has an inner surface 140 that defines opening 130. In the exemplary embodiment, inner surface 140 has a tiered or first configuration that facilitates securing washer 110 to body 120. More specifically, in the exemplary embodiment, inner surface 140 includes an upper portion 150 that is formed with an upper inner diameter 170, and a lower portion 160 that is formed with a lower inner diameter 180 that is smaller than upper inner diameter 170. Accordingly, in the exemplary embodiment, lower portion 160 is a recessed inner rim that extends circumferentially about opening 130.

In the exemplary embodiment, upper portion 150 is formed with an upper portion height 190, and lower portion 160 is formed with a lower portion height 200. Moreover, in the exemplary embodiment, upper portion 150 is substantially cylindrical and is defined by a continuous smooth wall, and lower portion 160 is formed with a continuous wall that includes a plurality of notches 210 that are spaced circumferentially about opening 130. Alternatively, inner surface 140 may have any other configuration that enables bushing assembly 100 to function as described herein.

In the exemplary embodiment, body 120 is substantially cylindrical and includes a bore 220 defined therethrough. In the exemplary embodiment, body 120 has a first end 230 that is sized to fit within opening 130 and a second end 240 that is opposite first end 230. Moreover, in the exemplary embodiment, first end 230 has an outer surface 250 that has a tiered or second configuration that enables washer 110 to be securely coupled to body 120. More specifically, in the exemplary embodiment, first end 230 includes a lip 260 that is substantially complementary to upper portion 150, and a plurality of projections 270 that extend radially outwards from body 120 and that are substantially complementary to lower portion 160 or, more particularly, notches 210. That is, at least a portion of outer surface 250 substantially mates against inner surface 140 when body 120 is fully inserted within opening 130. In the exemplary embodiment, lip 260 has a lip outer diameter 280 that is slightly smaller than upper inner diameter 170. Moreover, lip 260 is formed with a lip height 290 that is approximately the same as upper portion 150. In the exemplary embodiment, body 120 is formed with a body outer diameter 300 that is slightly smaller than lower inner diameter 180. Moreover, in the exemplary embodiment, projections 270 are sized, shaped, and/or oriented to mate with notches 210. More specifically, in the exemplary embodiment, projections 270 is formed with a projection height 310 that is approximately the same height as lower portion height 200. Alternatively, outer surface 250 may have any other configuration that enables bushing assembly 100 to function as described herein including, without limitation, a square or rectangle-shaped projection, a pyramidal shaped projection, a wedge-shaped projection, a rounded projection, and/or an irregular-shaped projection.

In the exemplary embodiment, body 120 is fabricated from a smart material that enables body 120 or, more particularly, first end 230 to selectively expand. The smart material may include, without limitation, a shape-memory alloy and/or a shape-memory polymer. In the exemplary embodiment, washer 110 is fabricated from a material that is compatible with the smart material used to fabricate body 120, such as, but not limited to, a carbon loaded polymeric material. For example, in the exemplary embodiment, the materials used to fabricate washer 110 and/or body 120 are substantially resistant to corrosion and/or electrostatic charge buildup. Alternatively, body 120 and/or washer 110 may be fabricated from any material or combination of materials that enables bushing assembly 100 to function as described herein.

Washer 110 and/or body 120 are configured to fit such that, when assembled, washer 110 and/or body 120 do not rotate with respect to each other. For example, in an alternative embodiment, an interference fit is formed between washer 110 and first end 230 with a suitable force such that washer 110 and/or body 120 do not include any notches 210 and/or projections 270. Additionally or alternatively, washer 110 and/or body 120 may have, without limitation, a polygonal shape, a square shape, and/or an oval shape. Washer 110 and/or body 120 may have any size, shape, and/or configuration that enables bushing assembly 100 to function as described herein.

During assembly of bushing assembly 100, second end 240 is inserted into opening 130, and body 120 is moved axially and/or rotated until first end 230 engages opening 130. More specifically, projections 270 are positioned in a tight tolerance within notches 210, and a lower surface 320 of lip 260 is positioned against an upper surface 330 of lower portion 160. Moreover, when body 120 is fully inserted in positioned relative to washer 110, an upper surface 340 of lip 260 is substantially flush with an upper surface 350 of upper portion 150.

In the exemplary embodiment, body 120 or, more particularly, first end 230 is expanded within opening 130 such that an interference fit is formed between washer 110 and first end 230. More specifically, in the exemplary embodiment, heat and/or other energy is applied to body 120 to facilitate transforming first end 230 from a strained, martensitic state to a shaped, austenitic state. During the transformation, first end 230 expands to fill opening 130 and become secured in opening 130 in an interference fit. Additionally, the expansion is reversible by applying energy that is opposite the originally applied energy, such as cooling through liquid nitrogen. Additionally or alternatively, a seal (not shown) may be positioned between washer 110 and body 120 such that a washer-body interface is substantially fluid tight. In such an embodiment, bushing assembly 100 may be suitable for use in a fuel application and/or a hydraulic application.

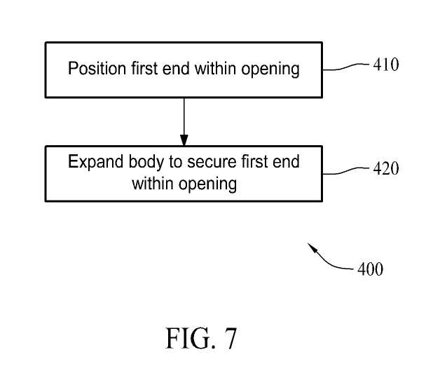

FIG. 7 is a flowchart of an exemplary method 400 that may be implemented to assemble bushing assembly 100. In the exemplary embodiment, first end 230 of body 120 is positioned 410 within opening 130 defined in washer 110. More specifically, in the exemplary embodiment, projections 270 are positioned substantially within notches 210 to facilitate aligning outer surface 250 with inner surface 140. Moreover, in the exemplary embodiment, lip 260 is positioned against lower portion 160 to fully insert body 120 within opening 130. More specifically, in the exemplary embodiment, upper surface 340 of lip 260 is substantially flush with upper surface 350 of upper portion 150 to facilitate fully inserting body 120 within opening 130. In at least some embodiments, a seal is positioned between washer 110 and body 120 such that a washer-body interface is substantially fluid tight.

As described in more detail above, in the exemplary embodiment, body 120 is fabricated from a smart material that is selectively expandable. In the exemplary embodiment, body 120 is expanded 420 to facilitate securing first end 230 within opening 130. More particularly, in the exemplary embodiment, body 120 is expanded 420 to secure first end 230 within opening 130 in an interference fit.

The subject matter described herein relates generally to bushings and, more particularly, to a bushing system including a bushing component and a separate flange component. The embodiments described herein enable benefits associated with both shape-memory bushings and flanged-bushings to be achieved. For example, the embodiments described herein enable increasing an opening's tolerance, increasing an ease of repair and/or replacement and/or decreasing damage to a structure in which the bushing assembly is installed.

Exemplary embodiments of systems and methods for using shape-memory bushings with flange features are described above in detail. The systems and methods are not limited to the specific embodiments described herein, but rather, components of systems and/or steps of the method may be utilized independently and separately from other components and/or steps described herein. Each component and each method step may also be used in combination with other components and/or method steps. Although specific features of various embodiments may be shown in some drawings and not in others, this is for convenience only. Any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A bushing assembly comprising:
a washer comprising an opening defined therethrough; and
a cylindrical body comprising a first end that is sized to be inserted within the washer opening and an opposite second end, said cylindrical body fabricated from a smart material that is configured to selectively expand when at least a portion of said body is positioned within the washer opening.

2. A bushing assembly in accordance with claim 1, wherein said cylindrical body is configured to be secured within the washer opening in an interference fit.

3. A bushing assembly in accordance with claim 1, wherein said washer further comprises an inner surface formed with a first configuration, and said cylindrical body first end further comprises an outer surface formed with a second configuration that is substantially complementary to the first configuration.

4. A bushing assembly in according with claim 1, wherein said washer further comprises a plurality of notches spaced circumferentially about the washer opening, and said first end of said cylindrical body further comprises a plurality of projections that are sized and oriented to fit within the plurality of notches.

5. A bushing assembly in accordance with claim 1, wherein said washer further comprises a recessed inner rim extending circumferentially about the washer opening, and said first end of said cylindrical body comprises a lip that is sized and oriented to fit within the recessed inner rim such that an upper surface of said cylindrical body is substantially flush with an upper surface of said washer when at least said portion of said cylindrical body is fully inserted within the washer opening.

6. A bushing assembly in accordance with claim 1, wherein said body is fabricated from a smart material comprising at least one of a shape-memory alloy and a shape-memory polymer.

7. A bushing assembly in accordance with claim 1 further comprising a seal disposed between said washer and said cylindrical body.

8. A bushing for use with a washer including an opening defined therethrough, said bushing comprising a cylindrical body comprising a first end that is sized to be inserted within the washer opening and an opposite second end, said cylindrical body fabricated from a smart material that is configured to selectively expand when at least a portion of said body is positioned within the washer opening.

9. A bushing in accordance with claim 8, wherein said cylindrical body is configured to be secured within the washer opening in an interference fit.

10. A bushing in accordance with claim 8, wherein said cylindrical body first end further comprises an outer surface formed with a configuration that is substantially complementary to an inner surface of the washer.

11. A bushing in according with claim 8, wherein said first end further comprises a plurality of projections that are sized and oriented to fit within a plurality of notches of the washer.

12. A bushing in accordance with claim 8, wherein said first end comprises a lip that is sized and oriented to fit within a recessed inner rim of the washer such that an upper surface of said cylindrical body is substantially flush with an upper surface of the washer when at least said portion of said cylindrical body is fully inserted within the washer opening.

13. A bushing assembly in accordance with claim 8, wherein said body is fabricated from a smart material comprising at least one of a shape-memory alloy and a shape-memory polymer.

14. A method of assembling a bushing assembly, said method comprising:
positioning a first end of a cylindrical body within an opening defined by a washer, the cylindrical body fabricated from a smart material that is configured to selectively expand; and
expanding the cylindrical body when the cylindrical body first end is positioned within the washer opening.

15. A method in accordance with claim 14, wherein expanding the cylindrical body further comprises expanding the cylindrical body such that the cylindrical body is secured within the washer opening in an interference fit.

16. A method in accordance with claim 14, wherein positioning a first end of a cylindrical body further comprises aligning the first end within the washer opening, the washer including an inner surface formed with a first configuration, the first end including an outer surface formed with a second configuration that is substantially complementary to the first configuration.

17. A method in according with claim 14, wherein positioning a first end of a cylindrical body further comprises aligning the first end within the washer opening, the washer including a plurality of notches spaced circumferentially about the washer opening, the first end including a plurality of projections that are sized and oriented to fit within the plurality of notches.

18. A method in accordance with claim 14, wherein positioning a first end of a cylindrical body further comprises positioning a lip of the first end within a recessed inner rim of the washer extending circumferentially about the washer opening such that an upper surface of the cylindrical body is substantially flush with an upper surface of the washer when the cylindrical body first end is fully inserted within the washer opening.

19. A method in accordance with claim 14 further comprising positioning a seal between the cylindrical body and the washer.
